(19) United States
(12) Patent Application Publication
(10) Pub. No.: US 2019/0104917 A1
(43) Pub. Date: Apr. 11, 2019

(54) Handheld Retractable Cleaning Sprayer

(71) Applicant: Rita Szutenbach Fasson, Littleton, CO (US)

(72) Inventors: Rita Szutenbach Fasson, Littleton, CO (US); Steven Anthony Szutenbach, Evergreen, CO (US)

(21) Appl. No.: 15/727,312

(22) Filed: Oct. 6, 2017

(51) Int. Cl. A47L 17/04; E03C 1/04; B05B 7/12

(52) U.S. Cl. CPC A47L 17/04; E03C 2001/0415; B05B 7/12; E03C 1/0404

(57) ABSTRACT

A device that combines a handheld retractable sprayer nozzle with an integrated soap/cleaning compartment for hot tubs, bathtubs, sinks, showers and other uses for residential, commercial, and industrial cleaning. The core elements are a nozzle with a rotating variable spray head, water selection knob, and distinctly, a compartment for tablets for soap, cleanser, etc. By using a self-contained closed system that eliminates additional suction hoses, containers, and multiple large soap containers this device will provide an easy to use product for end-users.

### BACKGROUND OF INVENTION

With large residential and commercial basins or machinery it is often cumbersome for the user to clean and rinse the object or objects, usually requiring the wetting down of the surfaces to be cleaned, applying soap from a separate source (e.g. bucket and sponge, siphoned liquid soap, etc.) then rinsing. The HRCS uniquely provides an all-in-one convenient solution to perform the wetting, soaping/cleaning, and rinsing functions all in one device.

The invention includes an adjustable spray nozzle connected to a hose. The hose is connected to the inner plumbing of a basin or other clean water source. At the base of the nozzle, and the top of the hose, is a ball valve that provides selections of Soap, Off, and Rinse settings. Above the ball valve is the tablet holder. To operate the HRCS, the user selects the desired water source, soap or rinse, to get a flow of water. Turning the ball valve selector to the right or left will give options for water flow. The top of the nozzle has a turnstile mechanism and allows for different types of spray.

### PRIOR ART

Spray nozzles of all sorts that are similar have been used for many decades and are useful primarily as rinsing or watering devices. Examples found:

US 2010/0125946, Faucet Having Pull-Out Spray Handle.

Uses the kitchen faucet to provide direct aeriated water flow. A second opening, in which the faucet body has an inner wall allows a mechanism to control the liquid flow through the faucet body. The invention is related to faucets including pull out sprayers for spraying a wide area at angles, particular with respect to such pull-out spraying faucets that are used for kitchen sink use.

US 20040211000, Sink Faucet with Integral Liquid Soap Dispensing Apparatus.

A manual or sensor type sink faucet for residential or commercial use, with an integral liquid soap dispensing system. A conduit extends internally through the faucet body from a remote supply of liquid soap. The conduit acts as a passage for the liquid soap to travel from the remote supply of liquid soap to outlet hole at the head of the faucet located directly over the sink bowl. The conduit can also be mounted externally to the faucet body and also dispense soap at the head of the faucet inside the sink bowl.

U.S. Pat. No. 5,906,319 Water/Soap Sprayer for Kitchen Faucets.

The main object of this invention is to provide a sensor or manual type sink faucet with an apparatus for dispensing liquid soap directly over the sink bowl. The apparatus can be mounted internally or externally to the sink faucet. Depending on the type of installation, the soap can be dispensed independently of or simultaneously with the water.

U.S. Pat. No. 3,718,149/Dish-Washer

In a dish-washing machine of the type having two separate washing zones in which delicate tableware and cooking utensils are respectively charged, there utensil washing zone and is operated as a result of rise of the washing temperature in the zone for the cooking utensils.

U.S. Pat. No. 3,770,205 Sprayer with Detergent or Chemical Additive Feed

A sprayer connectable to a hose and including a body having a compound four-position valve controlling a primary passageway and two sets of auxiliary passage ways. An antisiphon device attached to the body connects the hose to the primary passageway and terminates in a spray nozzle. The auxiliary passageways, shunting the primary passageway, include a common reservoir mounted on the underside of the body for containing either a liquid soap or detergent or pellets of a soluble chemical, such as a pesticide or plant food additive compound. The valve, operable by a finger lever, may be shifted from an “off” position where the main passageway is closed, to a “rinse” position where only the primary passageway is open, to a “liquid” position where both the primary and a first set of auxiliary passageways are open, and to a “pellet” position where both the primary and second the auxilat of auxiliary passageways are open.

### DETAILED SUMMARY OF INVENTION

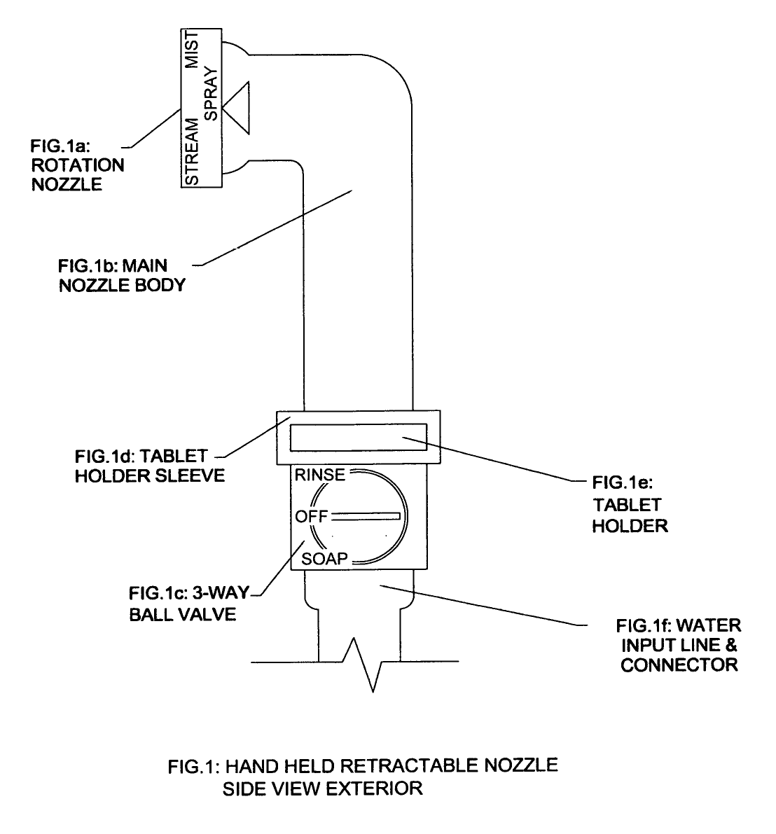

The HRCS provides a tool for ease in cleaning large basins, mechanisms, large surfaces, spas/hot tubs, etc. This device is attached to an adjustable length hose FIG. 1f, Water Input Line and Connector to be connected to a water source (plumbing, exterior faucet, etc.) and provide a flexible, easy to direct water stream for pre-rinse, cleaning, and rinsing. Above the Water Input Line and Connector, is the, FIG. 1c, 3-Way Ball Valve Assembly. This provides a single source of water for initial wetting, cleaning, and rinsing with the simple turning of the ball valve.

Choosing the option for cleaning, the water source flows through the FIG. 1d, Tablet Holder Sleeve/Splitter Compartment FIG. 1e, The Tablet Holder/Splitter Compartment Exterior View, has an indented compartment to insert a cleaning tablet. Once the desired tablet solution is placed inside the compartment, the nozzle bottom, with the ball valve, is re-attached to the main nozzle body. The detergent is applied as it flows through the FIG. 1b, Main Nozzle Body.

The HRCS will provide a single source for initial wetting, cleaning, and rinsing with a simple turning of the ball valve, introducing water flow through the tablet holder/sleeve/splitter compartment, through the main body and out the FIG. 1a, Rotating Nozzle Spray Selector.

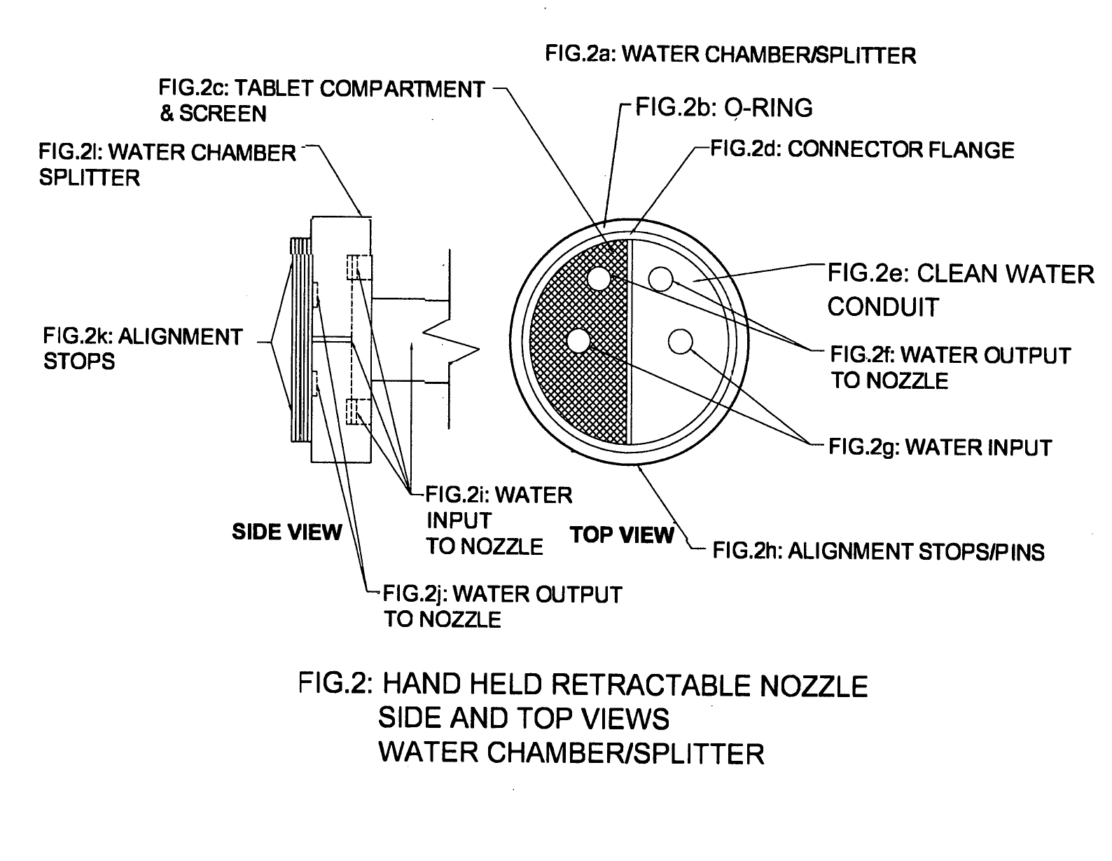

The user will be able to easily select the desired function via the ball valve which directs the source water either through the Tablet Holder Sleeve or the FIG. 2e, Clean Water Conduit Compartment. The option for ‘OFF’ is also available.

Once the proper source required is selected (soap water or clear water), users manually rotate the rotating nozzle spray selector the appropriate spray for the object or objects to be cleaned. Selections would include but are not restricted to—depending on the final configuration of the nozzle—stream, spray, mist, soak, etc. The spray selector would be from a current commercially available off-the-shelf product.

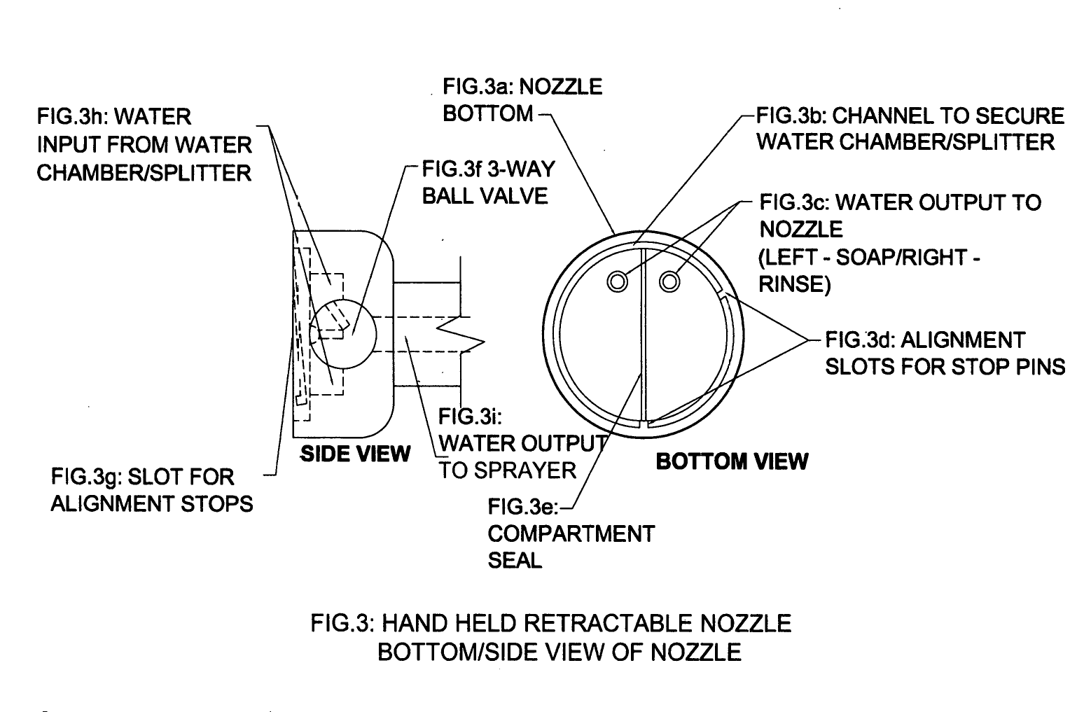

As shown in FIG. 3, Hand Held Retractable Nozzle Bottom/Side View the HRCS uniquely uses tablet(s), that are compressed solid products, designed to fit within the tablet holder FIG. 2c, Tablet Compartment and Screen, capable of providing immediate application of the selected solution. There will be a variety of available tablets that have various cleaning solutions. The Nozzle bottom as shown in FIG. 3a, Nozzle Bottom Internal Top View, is quickly and easily opened by way of a quick connect/disconnect channel to lock the bottom section of the holder as shown in FIG. 2, Handheld Retractable Nozzle—Side and Top Views Water Chamber/Splitter, to insert the selected product.

### BRIEF SUMMARY OF INVENTION

The HRCS nozzle is attached by a flexible hose to the water source with the length determined by user requirements. The water line attachment at the bottom of the nozzle FIG. 1f, Water Input Line and Connector is adaptable to various connections as required for residential or industrial needs. The water flows through the hose through the 3-way valve assembly. Once an option is selected on the device, the water continues to flow through the tablet/holder/sleeve compartment. Water continues to flow through the FIG. 1b, Main Nozzle Body and in FIG. 1a, The Rotating Nozzle Spray Selector the user selects one of the multiple spray options: spray, stream, shower, mist, etc. from the FIG. 3c, Water Output to Nozzle

### BRIEF DESCRIPTION OF DRAWINGS

Updated Hand Held Retractable Nozzle Fig. Descriptions

### Brief Description of Drawings

FIG. 1—Hand Held Retractable Nozzle—Left Side View/Exterior Showing Spray Selection and Valve water source selection knob

FIG. 1a—Rotating Nozzle Spray Selector—Commercial off the shelf spray selector

FIG. 1b—Main Nozzle Body—Left View of Entire Device

FIG. 1c—3-Way Ball Valve Assembly—Displays Exterior Selector Knob with Selections

FIG. 1d—Tablet Holder Sleeve/Splitter Compartment—Exterior

FIG. 1e—Tablet Holder/Splitter Compartment Exterior View—Holds Selected Tablet and is the Water Input/Output chambers

FIG. 1f—Water Input Line & Connector—External water supply connector

FIG. 2—Handheld Retractable Nozzle—Side External and Top Internal Views of Water Chamber/Splitter/Tablet Holder

FIG. 2a-Water Chamber/Splitter/Tablet Holder—Top View/Internal

FIG. 2b—O-Ring to seal Chamber to Nozzle body

FIG. 2c—Tablet Compartment and Screen—Compartment with Screen to hold Tablet and center seal separating soap and rinse water compartments

FIG. 2d—Connector Flange—Top view of protruding flange for twist on connection to Nozzle body

FIG. 2e—Clean Water Conduit Compartment—Compartment with center seal separating rinse water compartment from soap compartment

FIG. 2f—Water Output to Nozzle—Top View water output

FIG. 2g—Water Input—Water input from external water source

FIG. 2h—Alignment Stops/Pins—Top view showing pins for quick connect/disconnect to nozzle body

FIG. 2i—Water input—side view of external water source connector

FIG. 2j—Water output to nozzle—Output from Soap/Rinse Compartments

FIG. 2k—Alignment Stops—Pins to insert into quick disconnect slots

FIG. 2l—Water Chamber Splitter

FIG. 3—Hand Held Retractable Nozzle—Bottom/Side Views of Nozzle

FIG. 3a—Nozzle Bottom Internal Top View—Connection to Nozzle Body

FIG. 3b—Channel to secure water chamber/splitter to Nozzle Body

FIG. 3c—Water Output Top View—Water from To Nozzle (Left—Soap/Right—Rinse)

FIG. 3d—Alignment Slots for Stop Pins

FIG. 3e—Compartment Seal

FIG. 3f—Side View 3-way ball valve—Diverts External Source Water to selected chamber

FIG. 3g—Side View Slot for Alignment Stops

FIG. 3h—Water Input to Water Chamber/Splitter

FIG. 3i—Water Output to Sprayer

1. A handheld retractable nozzle is easily pulled from its base to extend the hose to a length desired by the user.

2. The water line is attached to a water source underneath the unit to easily access from the nozzle section of the device.

3. The uniqueness of this device, is the 3-way ball valve selector. This apparatus is attached to the water input line and connector, providing a single source for initial application of soap, rinsing and off selectors, with a simple turning of the ball valve. The ball valve selector is manually rotated for the user to determine which option is beneficial for the task at hand. With one rotation, the user uses the device for wetting the surface; another rotation, applies detergent; a rotation, again, provides a rinsing action or turn off water flow completely to the nozzle.

4. The nozzle sprayer allows for various options of water flows: stream, spray, mist, soak, etc.

5. The tablet holder sleeve, allows the user to insert a detergent packet into the unit with ease by way of the quick connect/disconnect flange that removes the ball valve section.
